(19) United States
(12) Patent Application Publication
(10) Pub. No.: US 2006/0195349 A1
(43) Pub. Date: Aug. 31, 2006

(54) Weight estimating system and method for products of orders

(75) Inventors: Min-Tzu Sung, Taipei (TW); Shan-Fa Shih, Taipei (TW); Wen-Yi Chang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/067,523

(22) Filed: Feb. 25, 2005

(51) Int. Cl. G05B 19/418; G06F 15/02; G06F 9/46

(52) U.S. Cl. 705/8; 705/9

(57) ABSTRACT

A weight estimating system and a weight estimating method are proposed for products of orders. The weight estimating system includes an order database for storing order related data for clients; a pallet database for storing pallet weights and product quantities per pallet; a declaration product list database for storing data required for declaration; a data inputting module for allowing a user to establish the order and pallet databases and select an order to be declared; a weight estimating module for calculating estimated product weights of each order; and a data accessing module for storing the estimated product weights of each order calculated by the weight estimating module into the order database, the estimated product weights serving as reference for declaration. This avoids delay of the time of declaration and delay of export of products due to failure in timely measuring weights of the products.

### FIELD OF THE INVENTION

The present invention relates to weight estimating systems and methods for products of orders, and more particularly, to a system and method capable of estimating product weights of each order before declaration.

### BACKGROUND OF THE INVENTION

Related information and actual weights of products before being exported must be provided within a time period prescribed by the Customs prior to performing a declaration procedure. However, in practical implementation, usually due to delay of product fabrication, weight measurement of the products cannot be completed within the time period prescribed by the Customs, thereby failing to provide actual weights of the products before the prescribed deadline. This thus postpones the time of declaration and leads to delay of export of the products.

Conventionally, in order to prevent delay of the export of products caused by failure in measuring product weights and providing information for declaration in time, it is usually to manually calculate an estimated weight of each product of an order, and enter the estimated weights into a declaration product list database for performing the declaration procedure. However, the manual calculation of estimated weights is labor- and time-consuming, and also causes significant inconsistency or deviation between the estimated weights and actual weights due to human negligence and calculation errors. This makes the declaration procedure fail and need to be repeated, and thus delays the export of products.

Therefore, the problem to be solved here is to provide a weight estimating system and method for products of orders so as to overcome the foregoing drawbacks.

### SUMMARY OF THE INVENTION

In light of the above prior-art drawbacks, a primary objective of the present invention is to provide a weight estimating system and method for products of orders, whereby total weights of products of each of the orders can be calculated for a user and serve as reference for declaration, so as to avoid delay of the time of declaration and delay of export of the products due to failure in providing actual weights of products in time, and also prevent significant inconsistency or deviation between estimated weights and actual weights of products due to human negligence and calculation errors, such that declaration needs not be repeated and the export of products would not be delayed.

In accordance with the above and other objectives, the present invention proposes a weight estimating system for products of orders, comprising an order database for storing order related data such as order codes, client names, product names, product weights, ordered quantities, product sales prices, product sizes, estimated product weights and so on; a pallet database for storing pallet weights, product names, and product quantities per pallet; a declaration product list database for storing data required for declaration such as product names, export product quantities, product sales prices, product sizes, estimated product weights and so on; a data inputting module for a user to establish the order and pallet databases and select one of the orders to be declared; a weight estimating module for calculating estimated product weights of each of the orders according to the order related data and the data in the pallet database; and a data accessing module for storing the estimated product weights of each of the orders calculated by the weight estimating module into the order database, and transmitting data required for declaration in the order database to the declaration product list database, the declaration related data serving as reference for declaration. This thus avoids delay of the time of declaration and delay of export of the products due to failure in timely measuring the weights of products.

The present invention also proposes a weight estimating method for products of orders, which is performed by the following steps. Firstly, order related data such as order codes, client names, product names, product weights, ordered quantities, product sales prices, product sizes and so on are stored in an order database, and data such as pallet weights, product names, and product quantities per pallet are stored in a pallet database, wherein the stored data are used for calculating estimated product weights of each of the orders for a user. Subsequently, the product weights and the ordered quantities of each of the orders are read from the order database, and then the pallet weights and the product quantities per pallet are read from the pallet database, such that the estimated product weights of each of the orders can be calculated and are stored in the order database. Detailed data and the estimated product weights of each of the orders are read from the order database, such that the user is able to select one of the orders to be declared. Finally, data required for declaration such as product names, export product quantities, product sales prices, product sizes, estimated product weights and so on for the selected order are transmitted from the order database to a declaration product list database, such that a declaration form can be produced and a declaration procedure can be performed.

Therefore, by the weight estimating system and method for products of orders in the present invention, the order related data are stored in the order database, and pallet related data such as pallet weights, etc. are stored in the pallet database, such that the weight estimating module can calculate estimated product weights of each of the orders according to the order related data and the pallet related data. Thus, data of an order to be declared can be selected by the user and transmitted to the declaration product list database so as to produce the declaration form and perform the declaration procedure.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram showing basic architecture of a weight estimating system for products of orders according to the present invention; and

FIG. 2 is a flowchart showing steps of a weight estimating method for products of orders according to the present invention.

### DETAILED DESCRIPTION OF THE PREFERRED EMBODIMENTS

The following embodiments are used to describe the present invention in detail but not for limiting the scope of the invention.

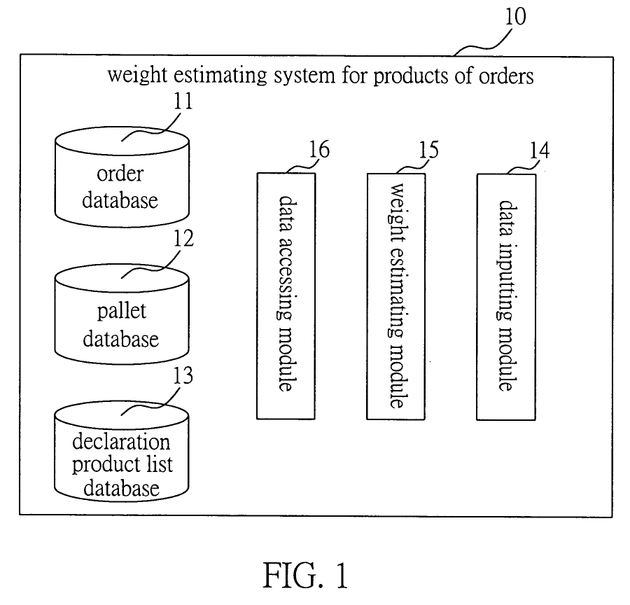

FIG. 1 is a block diagram showing basic architecture of a weight estimating system for products of orders according to the present invention. As shown in FIG. 1, the weight estimating system for products of orders in the present invention comprises an order database 11, a pallet database 12, a declaration product list database 13, a data inputting module 14, a weight estimating module 15, and a data accessing module 16.

The order database 11 is used to store order related data such as order codes, client names, product names, product weights, ordered quantities, product sales prices, product sizes, estimated product weights and so on, which are used for calculating estimated product weights of each of the orders for a user and serve as reference for declaration.

The pallet database 12 is used to store pallet related data such as pallet weights, product names, and product quantities per pallet, which are used for calculating the estimated product weights of each of the orders for the user.

The declaration product list database 13 is used to store data required for declaration such as product names, export product quantities, product sales prices, product sizes, estimated product weights and so on, so as for producing a declaration form and performing a declaration procedure. In order to simplify the drawings and description for the present invention, only data for declaration relating to the present invention are shown in the declaration product list database. However, the actual data for declaration stored in such database should depend on regulations of the declaration procedure in each country.

The data inputting module 14 is used to allow the user to establish the order database 11 and the pallet database 12 and select one of the orders to be declared, such that products of the selected order would be subjected to the declaration procedure.

The weight estimating module 15 is used to read the product names, the product weights and the ordered quantities of each of the orders from the order database 11, and read the pallet weight and the product quantity per pallet from the pallet database 12 according to each of the product names, such that an estimated weight of each product of each of the orders can be calculated by the following formula: (product weight)*(ordered quantity)+(pallet weight)*[ordered quantity/product quantity per pallet]=estimated weight of the product. If a calculated result of [ordered quantity/product quantity per pallet] is not an integer, the first digit of the calculated result before a decimal point is added by 1 and digits after the decimal point are discarded.

The data accessing module 16 is used to store the estimated product weights calculated by the weight estimating module 15 into the order database 11, and transmit data required for declaration such as the product names, the ordered quantities, the product sales prices, the product sizes, the estimated product weights and so on stored in the order database 11 to the declaration product list database 13 for the user, such that the declaration form can be produced and the declaration procedure can be performed.

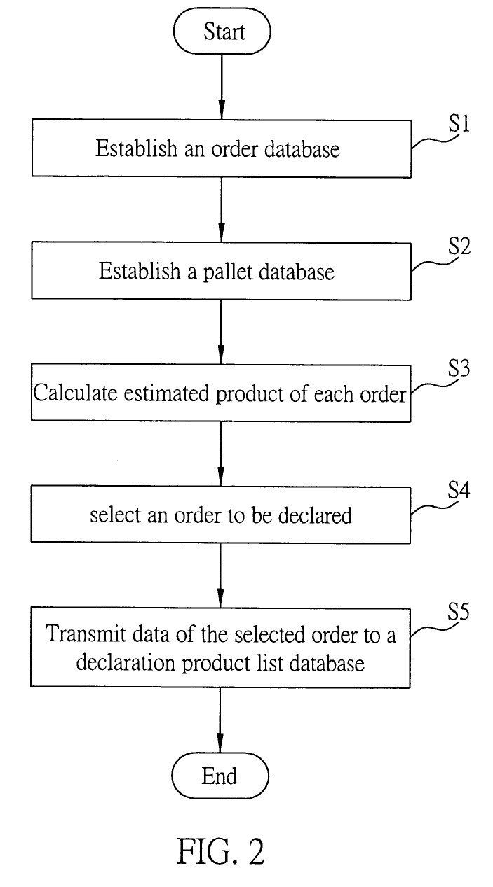

FIG. 2 is a flowchart showing steps of a weight estimating method for products of orders according to the present invention. Referring to FIG. 2, firstly, in Step S1, an order database 11 is established for storing order related data such as order codes, client names, product names, product weights, ordered quantities, product sales prices, product sizes and so on, which are used for calculating estimated product weights of each of the orders for a user and serve as reference for declaration. Then, it proceeds to Step S2.

In Step S2, a pallet database 12 is established for storing pallet related data such as pallet weights, product names, and product quantities per pallet, which are used for calculating the estimated product weights of each of the orders for the user. Then, it proceeds to Step S3.

In Step S3, a weight estimating module 15 reads the product names, the product weights and the ordered quantities of each of the orders from the order database 11, and reads the pallet weight and the product quantity per pallet from the pallet database 12 according to each of the product names. Subsequently, the weight estimating module 15 calculates an estimated weight of each product of each of the orders according to the following formula: (product weight)*(ordered quantity)+(pallet weight)*[ordered quantity/product quantity per pallet]=estimated weight of the product. Then, a data accessing module 16 is actuated to store the estimated product weights into the order database 11. If a calculated result of [ordered quantity/product quantity per pallet] is not an integer, the first digit of the calculated result before a decimal point is added by 1 and digits after the decimal point are discarded. Then, it proceeds to Step S4.

In Step S4, all the order related data stored in the order database 11 are displayed, and a data inputting module 14 is actuated to allow the user to select data of one of the orders to be declared. Then, it proceeds to Step S5.

In Step S5, the data accessing module 16 is actuated to transmit data required for declaration such as the product names, the ordered quantities, the product sales prices, product sizes and the estimated product weights in the order database 11 for the selected order to a declaration product list database 13, so as to produce a declaration form and perform a declaration procedure.

Therefore, by the weight estimating system and method for products of orders in the present invention, the order related data are stored in the order database, and the pallet related data such as pallet weights, etc. are stored in the pallet database, such that the weight estimating module can calculate estimated product weights of each of the orders according to the order related data and the pallet related data. Thus, data of an order to be declared can be selected by the user and transmitted into the declaration product list database so as to produce the declaration form and perform the declaration procedure.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A weight estimating system for products of orders, comprising:
an order database for at least storing order related data comprising product names, ordered quantities and product weights;
a pallet database for at least storing pallet related data comprising pallet weights and product quantities per pallet;
a weight estimating module for reading the order related data of product names, ordered quantities and product weights stored in the order database and reading the pallet related data of pallet weights and product quantities per pallet stored in the pallet database, so as to calculate estimated product weights of each of the orders according to a predetermined formula; and
a data accessing module for storing the estimated product weights of each of the orders calculated by the weight estimating module into the order database.

2. The weight estimating system for products of orders of claim 1, further comprising a data inputting module for allowing a user to select data of one of the orders to be declared.

3. The weight estimating system for products of orders of claim 1, further comprising a declaration product list database for storing data required for declaration.

4. The weight estimating system for products of orders of claim 3, wherein the data required for declaration are transmitted from the order database.

5. The weight estimating system for products of orders of claim 1, wherein the predetermined formula is (product weight)*(ordered quantity)+(pallet weight)*[ordered quantity/product quantity per pallet]=estimated weight of a product of each of the orders.

6. The weight estimating system for products of orders of claim 5, wherein if a calculated result of [ordered quantity/product quantity per pallet] is not an integer, a first digit of the calculated result before a decimal point is added by 1 and digits after the decimal point are discarded.

7. A weight estimating method for products of orders, comprising the steps of:
at least storing order related data comprising product names, ordered quantities and product weights into an order database, and at least storing pallet related data comprising pallet weights and product quantities per pallet into a pallet database;
reading the order related data of product names, ordered quantities and product weights stored in the order database, and reading the pallet related data of pallet weights and product quantities per pallet stored in the pallet database, so as to calculate estimated product weights of each of the orders according to a predetermined formula; and
storing the estimated product weights of each of the orders into the order database.

8. The weight estimating method for products of orders of claim 7, further comprising a step of selecting data of one of the orders to be declared from the order database.

9. The weight estimating method for products of orders of claim 8, further comprising a step of transmitting the data of the selected order to a declaration product list database so as to produce a declaration form and perform a declaration procedure.

10. The weight estimating method for products of orders of claim 7, wherein the predetermined formula is (product weight)*(ordered quantity)+(pallet weight)*[ordered quantity/product quantity per pallet]=estimated weight of a product of each of the orders.

11. The weight estimating method for products of orders of claim 10, wherein if a calculated result of [ordered quantity/product quantity per pallet] is not an integer, a first digit of the calculated result before a decimal point is added by 1 and digits after the decimal point are discarded.
